(19) United States
(12) Patent Application Publication
(10) Pub. No.: US 2025/0370882 A1
(43) Pub. Date: Dec. 4, 2025

(54) MANAGING THE BACKUP OF A DATABASE

(71) Applicant: International Business Machines Corporation, Armonk, NY (US)

(72) Inventors: Michael William Rennie, Greely (CA); Silenio Sulivan Quarti, Ontario (CA); Libing Wang, Manotick (CA)

(21) Appl. No.: 18/675,223

(22) Filed: May 28, 2024

(51) Int. Cl. G06F 11/14; G06F 16/27

(52) U.S. Cl. CPC G06F 11/1464; G06F 11/1461; G06F 16/27; G06F 2201/80; G06F 2201/84

(57) ABSTRACT

Computer-implemented methods for managing the backup of a database are provided. Aspects include receiving, by a secondary database stored in a second cloud environment, a continuous replication of a primary database stored in a first cloud environment, instructing a file system of the second cloud environment to capture a snapshot of the secondary database, and transmitting the snapshot to a data storage system for storage. The file system of the second cloud environment utilizes logical volume management.

### BACKGROUND

The present disclosure generally relates to database storage, and more specifically, to managing a backup of a database.

Most, if not all, organizations that store data in database backup their databases to provide data protection, to provide business continuity, to meet compliance requirements, to provide disaster recovery, and the like. In general, database backups can be categorized as either continuous or non-continuous.

Continuous database backups involve capturing changes to the database in near real-time or at frequent intervals and typically use database replication to continuously record changes as they occur. Continuous backups offer several benefits including minimal data loss, fast recovery, and scalability. However, continuous backups do not provide precise point-in-time recovery. Non-continuous backups, also known as periodic or scheduled backups, involve taking snapshots of the database at specific intervals (e.g., daily, weekly). These backups capture the state of the database at the time the backup was initiated. Non-continuous backups are often simpler to implement and manage compared to continuous backup solutions and generally are less resource-intensive compared to continuous backups. However, non-continuous backups may experience data loss in the event of a failure between backup intervals and recovery from non-continuous backups may be time-consuming for large datasets, especially if the backup interval is relatively long and significant data changes have occurred since the last backup.

### SUMMARY

Embodiments of the present disclosure are directed to computer-implemented methods for managing a backup of a database. According to an aspect, a computer-implemented method includes receiving, by a secondary database stored in a second cloud environment, a continuous replication of a primary database stored in a first cloud environment, instructing a file system of the second cloud environment to capture a snapshot of the secondary database, and transmitting the snapshot to a data storage system for storage. The file system of the second cloud environment utilizes logical volume management.

Embodiments also include computing systems and computer program products for managing a backup of a database.

Additional technical features and benefits are realized through the techniques of the present disclosure. Embodiments and aspects of the disclosure are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the present disclosure are apparent from the following detailed description taken in conjunction with the accompanying drawings in which:

FIG. 1 depicts a block diagram of an example computer system for use in conjunction with one or more embodiments of the present disclosure;

FIG. 2 depicts a block diagram of a system for managing a backup of a first database in accordance with one or more embodiments of the present disclosure;

FIG. 3 depicts a flowchart of a method for configuring a system for managing a backup of a first database in accordance with one or more embodiments of the present disclosure; and

FIG. 4 depicts a flowchart of a method for managing a backup of a first database in accordance with one or more embodiments of the present disclosure.

### DETAILED DESCRIPTION

As described above, existing continuous or non-continuous methods are currently used to backup databases. While non-continuous backup methods offer precise point-in-time recovery, non-continuous backup methods often do not scale well for large datasets. For example, data inconsistencies can occur when entries within a database are changed while batches are being backed up. Conversely, while continuous backup methods offer strong consistency, continuous backup methods do not provide precise point-in-time recovery of the database.

In exemplary embodiments, systems, methods, and computer program products for managing the backup of a database are provided. In exemplary embodiments, a database is backed up using a combination of continuous and non-continuous methods to provide strong data consistency and point-in-time recovery. In exemplary embodiments, a first database is provided in a first cloud environment. The first database is continuously replicated to a secondary database that is disposed in a second cloud environment, where the second cloud environment is configured with a file system that supports snapshotting. In exemplary embodiments, the second cloud environment is configured to periodically capture a snapshot of the secondary database. The captured snapshots are then stored locally in the second cloud environment, in a separate data storage system, or both. In exemplary embodiments, when an error is discovered in the first database the first database and the second database can be restored to a precise point in time based on one of the stored snapshots.

Various aspects of the present disclosure are described by narrative text, flowcharts, block diagrams of computer systems, and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment ("CPP embodiment" or “CPP”) is a term used in the present disclosure to describe any set of one, or more, storage media (also called "mediums") collectively included in a set of one, or more, storage devices that collectively include machine readable code corresponding to instructions and/or data for performing computer operations specified in a given CPP claim. A "storage device" is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits / lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as performing variable length simulation to test an integrated circuit design as shown at block 150. In addition to block 150, computing environment 100 includes, for example, computer 101, wide area network (WAN) 102, end user device (EUD) 103, remote server 104, public Cloud 105, and private Cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI), device set 123, storage 124, and Internet of Things (IoT) sensor set 125), and network module 115. Remote server 104 includes remote database 132. Public Cloud 105 includes gateway 130, Cloud orchestration module 131, host physical machine set 142, virtual machine set 143, and container set 144.

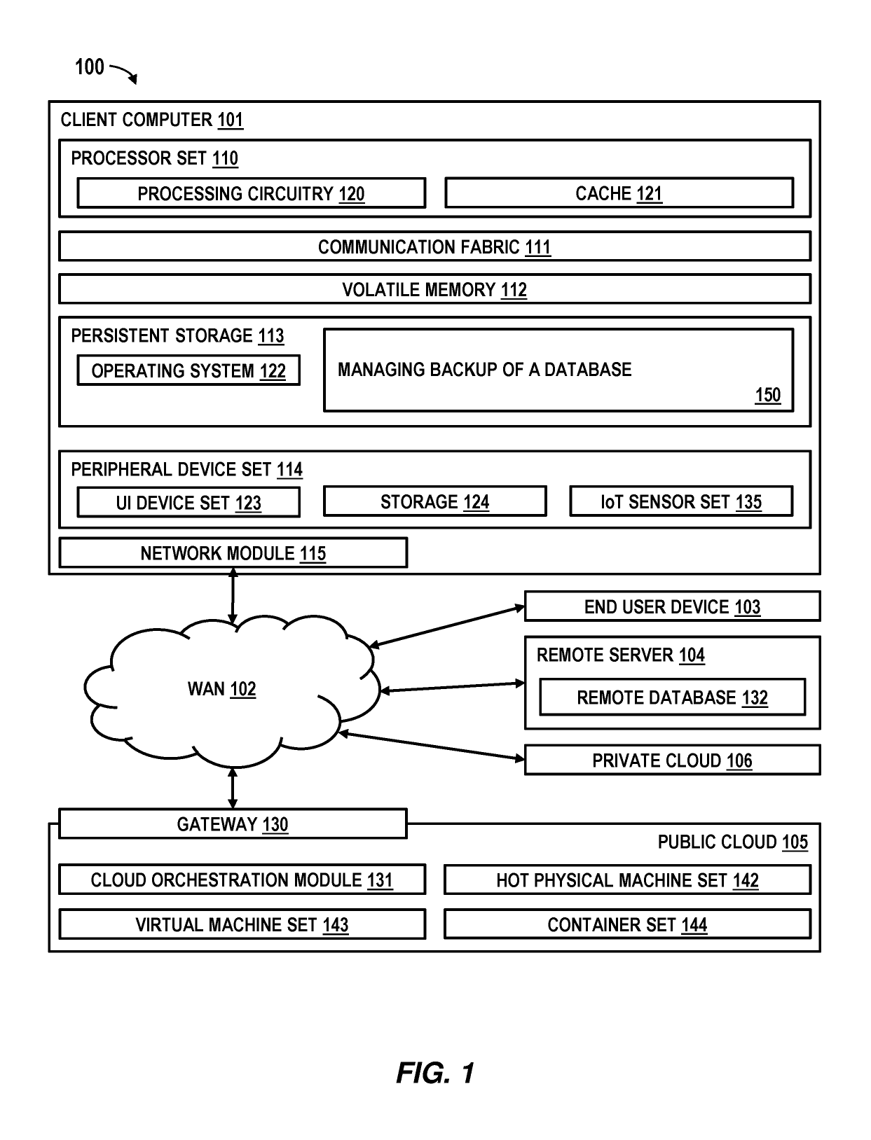

COMPUTER 101 may take the form of a desktop computer, laptop computer, tablet computer, smart phone, smart watch or other wearable computer, mainframe computer, quantum computer, a small single board computer (e.g. a Raspberry Pi) or any other form of computer or mobile device now known or to be developed in the future that is capable of running a program, accessing a network or querying a database, such as remote database 132. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a Cloud, even though it is not shown in a Cloud in FIG. 1. On the other hand, computer 101 is not required to be in a Cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input / output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collects and store helpful and useful data for use by other computers, such as computer 101. For example, in a hypothetical case where computer 101 is designed and programmed to provide a recommendation based on historical data, then this historical data may be provided to computer 101 from remote database 132 of remote server 104.

PUBLIC CLOUD 105 is any computer system available for use by multiple entities that provides on-demand availability of computer system resources and/or other computer capabilities, especially data storage (Cloud storage) and computing power, without direct active management by the user. Cloud computing typically leverages the sharing of resources to achieve coherence and economies of scale. The direct and active management of the computing resources of public Cloud 105 is performed by the computer hardware and/or software of Cloud orchestration module 131. The computing resources provided by public Cloud 105 are typically implemented by virtual computing environments that run on various computers making up the computers of host physical machine set 142, which is the universe of physical computers in and/or available to public Cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after the instantiation of the VCE. Cloud orchestration module 131 manages the transfer and storage of images, deploys new instantiations of VCEs, and manages active instantiations of VCE deployments. Gateway 130 is the collection of computer software, hardware, and firmware that allows public Cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public Cloud 105, except that the computing resources are only available for use by a single enterprise. While private Cloud 106 is depicted as being in communication with WAN 102, in other embodiments a private Cloud may be disconnected from the internet entirely and only accessible through a local/private network. A hybrid Cloud is a composition of multiple Clouds of different types (for example, private, community, or public Cloud types), often respectively implemented by different vendors. Each of the multiple Clouds remains a separate and discrete entity, but the larger hybrid Cloud architecture is bound together by standardized or proprietary technology that enables orchestration, management, and/or data/application portability between the multiple constituent Clouds. In this embodiment, public Cloud 105 and private Cloud 106 are both part of a larger hybrid Cloud.

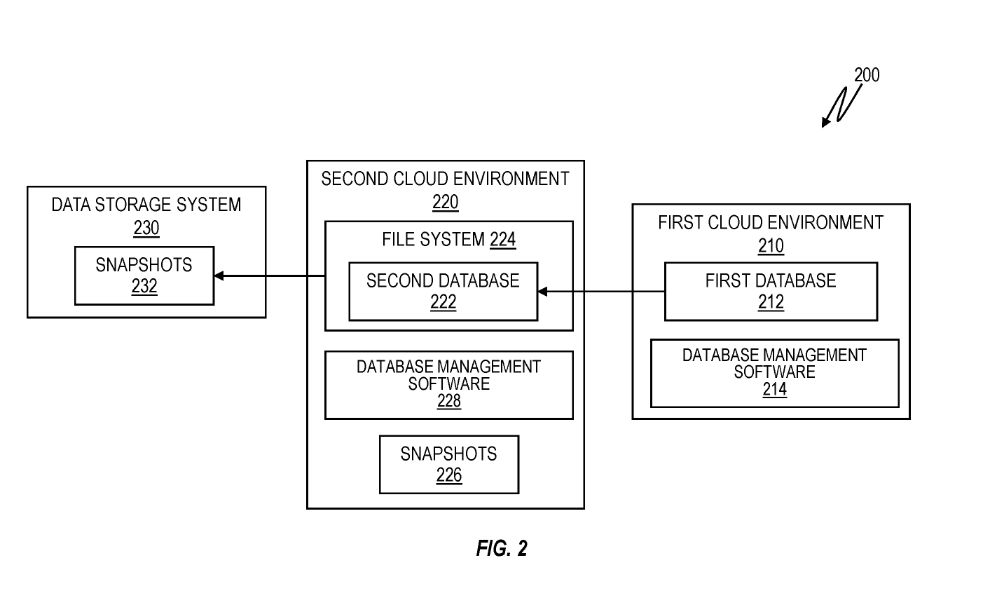

Referring now to FIG. 2, a block diagram of a system 200 for managing a backup of a first database in accordance with one or more embodiments of the present disclosure is shown. In exemplary embodiments, the system 200 includes a first cloud environment 210 and a second cloud environment 220. In exemplary embodiments, the first cloud environment 210 and the second cloud environment 220 may be embodied in one of a public cloud 105 or a private cloud 106 such as those shown in FIG. 1. In exemplary embodiments, the system 200 includes a first database 212, also referred to herein as a primary database, that is deployed in the first cloud environment 210. The system 200 also includes a second database 222, also referred to herein as a backup database, that is deployed in the second cloud environment 220. The second database 222 is configured as a continuous backup of the first database 212. In exemplary embodiments, the first database 212 is continuously backed up to the second database 222 using continuous data replication. Continuous data replication involves replicating changes made to the first database 212 to the second database 222 in real-time. This can be achieved using various technologies such as database mirroring, log-based replication, or change data capture (CDC). Continuous replication ensures that the second database 222 is kept synchronized with the first database 212, allowing for rapid failover and recovery in case of a failure of the first database 212.

In exemplary embodiments, the second database 222 is stored in a file system 224 of the second cloud environment 220 that supports snapshotting. Snapshotting, or creating snapshots, is the process of capturing the state of data at a specific moment, allowing users to access and restore that data as it was at the time the snapshot was taken. Several cloud-based file systems and storage solutions support snapshotting, providing users with a convenient way to protect their data and applications. For example, the file system 224 may be one of an Amazon Elastic File System (EFS), Google Cloud Filestore, Microsoft Azure Files, Nutanix Files (formerly AFS), IBM Spectrum Scale, OpenShift Data Foundation file system, and a General Parallel Filesystem (GPFS). Each of these cloud-based file systems offers snapshotting as a built-in feature, providing users with a convenient and reliable way to protect their data and ensure business continuity.

In exemplary embodiments, file system 224 is utilized to create and store snapshots 226 of the second database 222. In exemplary embodiments, the second database 222 is stored in a persistence volume that of the file system 224 that is reserved from the second database 222. In one embodiment, the first cloud environment 210 includes a database management software 214 that is configured to perform the continuous data replication of the first database 212 to the second database 222 and the second cloud environment 220 includes a database management software 228 that is configured to periodically instruct the file system 224 to create and store snapshots 226 of the second database 222. In exemplary embodiments, the database management software 228 determines the frequency that the file system 224 is utilized to create and store snapshots 226 based on input from an administrator of the first database 212 and/or the second database 222.

In exemplary embodiments, one or more of the snapshots 226 created by the file system 224 can be stored in the second cloud environment 220 and/or one or more of the snapshots 232 created by the file system 224 can be stored in a data storage system 230 that is separate from the second cloud environment 220. In exemplary embodiments, the database management software 228 determines both the frequency of the creation of the snapshots 226, 232 and the locations that the snapshots are stored in. In one embodiment, snapshots 226 are obtained and stored with a first frequency, such as once per hour, and snapshots 232 are obtained and stored with a second frequency that is less frequent than the first frequency, such as once per day.

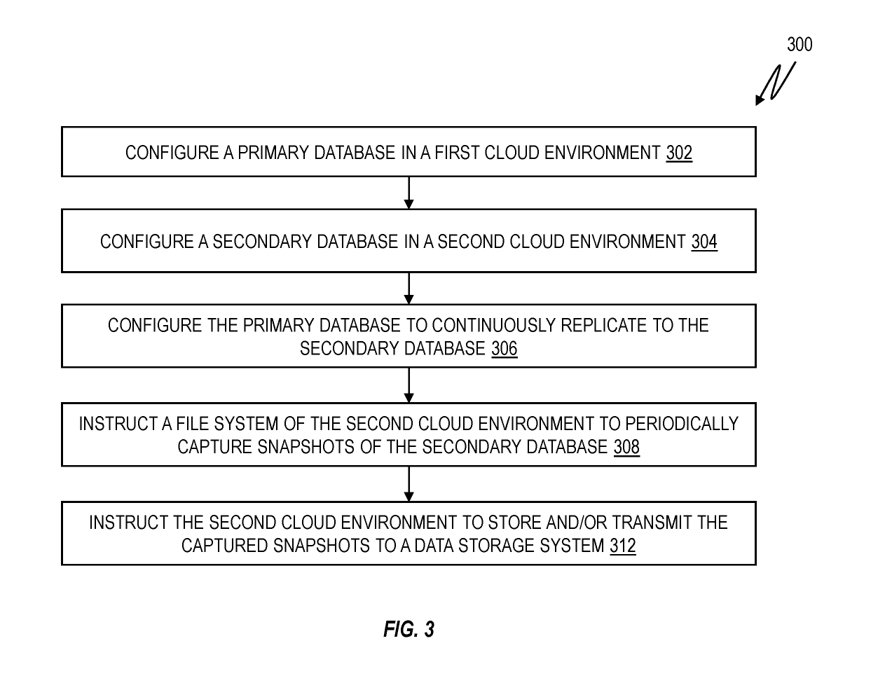

Referring now to FIG. 3, a flowchart of a method 300 for configuring a system for managing a backup of a first database in accordance with one or more embodiments of the present disclosure is shown. In one embodiment, the method 300 is performed by a database administrator utilizing database management software 214 and 228. As shown at block 302, the method 300 includes configuring a primary database in a first cloud environment. Next, as shown at block 304, the method 300 includes configuring a secondary database in a second cloud environment. As shown at block 306, the method 300 includes configuring the primary database to continuously replicate to the secondary database. Once the primary and secondary databases have been configured and the primary database is continuously replicated to the secondary database, the method 300 includes instructing a file system of the second cloud environment to periodically capture snapshots of the secondary database. For example, the file system may include one or more persistent storage volumes that are used to store the secondary database, and a database management software is configured to instruct the file system to capture a snapshot of the one or more persistent storage volumes. As shown at block 312, the method 300 includes instructing the second cloud environment to store and/or transmit the captured snapshots to a data storage system. In exemplary embodiments, a database management software disposed on the second cloud environment is configured to control where to store the snapshots created by the file system based on instructions provided by a database administrator.

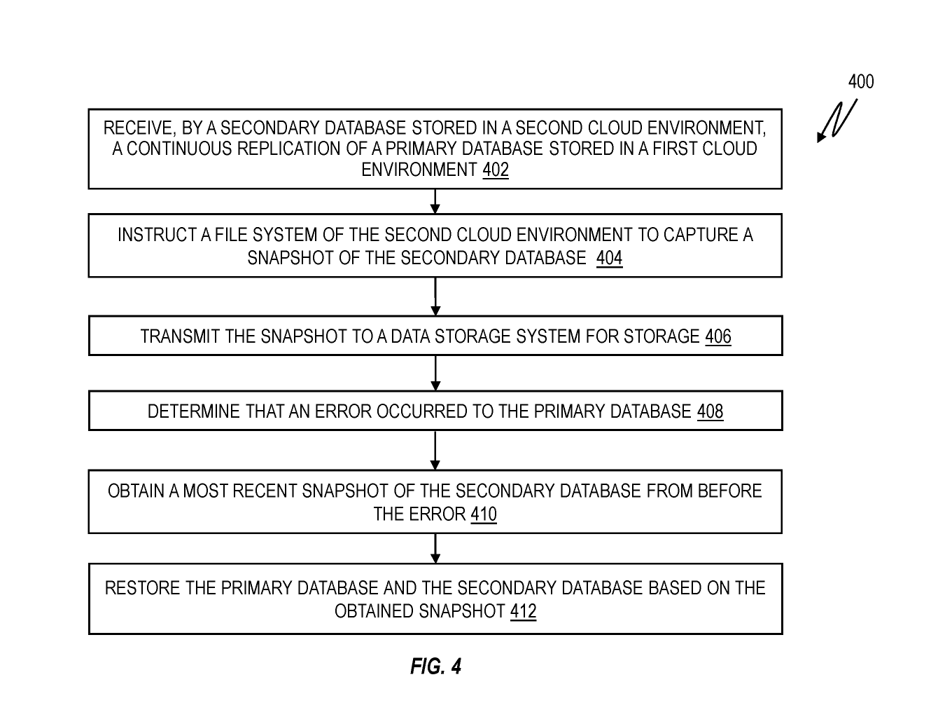

Referring now to FIG. 4, a flowchart of a method 400 for managing a backup of a first database in accordance with one or more embodiments of the present disclosure is shown. In one embodiment, the method 400 is performed by a database management software disposed 228 on the second cloud environment 220, such as the one shown in FIG. 2. As shown at block 402, the method 400 includes receiving, by a secondary database stored in a second cloud environment, a continuous replication of a primary database stored in a first cloud environment. Next, as shown at block 404, the method 400 includes instructing a file system of the second cloud environment to capture a snapshot of the secondary database. In exemplary embodiments, the second cloud environment includes a file system that is designed to natively support snapshotting. Once a snapshot of the secondary database is captured, the method 400 includes transmitting the snapshot to a data storage system for storage, as shown at block 406. In exemplary embodiments, the snapshot may also be stored in the second cloud environment.

Next, as shown at block 408, the method 400 includes determining that an error occurred to the primary database. In exemplary embodiments, by the time the determination is made that the error occurred in the primary database, the error has already been replicated in the secondary database, as a result, both the primary database and the secondary database include the error. At block 410, the method 400 includes obtaining the most recent snapshot of the secondary database from before the error. In exemplary embodiments, each snapshot is stored with a timestamp that corresponds to when the snapshot was captured. The snapshot may be obtained from a data storage device or from a storage device that is part of the second cloud environment. The method 400 concludes at block 412 by restoring both the primary database and the secondary database based on the obtained snapshot.

In exemplary embodiments, by utilizing a combination of continuous and non-continuous methods for backing up a database both strong data consistency and point-in-time recovery of the database can be obtained. In addition, by utilizing a file system of a cloud environment that stores a secondary copy of a primary database, the complexity of capturing snapshots of the database is managed by the file system, thereby simplifying the point-in-time backup process.

In exemplary embodiments, the primary database may be one of a Cloudant database, a Postgresql database, a Mongo database, or the like. In one embodiment, the primary database is replicated to the secondary database by the secondary database pulling update information, e.g., by obtaining and applying logs of updates to the primary database. In exemplary embodiments, the replication between the primary database and the secondary database continues during the capture of snapshots of the file system containing the secondary database.

Various embodiments are described herein with reference to the related drawings. Alternative embodiments can be devised without departing from the scope of the present disclosure. Various connections and positional relationships (e.g., over, below, adjacent, etc.) are set forth between elements in the following description and in the drawings. These connections and/or positional relationships, unless specified otherwise, can be direct or indirect, and the present disclosure is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

One or more of the methods described herein can be implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

For the sake of brevity, conventional techniques related to making and using aspects of the present disclosure may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

In some embodiments, various functions or acts can take place at a given location and/or in connection with the operation of one or more apparatuses or systems. In some embodiments, a portion of a given function or act can be performed at a first device or location, and the remainder of the function or act can be performed at one or more additional devices or locations.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The present disclosure has been presented for purposes of illustration and description, but is not intended to be exhaustive or limited to the form disclosed. Many modifications and variations will be apparent to those of ordinary skill in the art without departing from the scope and spirit of the disclosure. The embodiments were chosen and described in order to best explain the principles of the disclosure and the practical application, and to enable others of ordinary skill in the art to understand the disclosure for various embodiments with various modifications as are suited to the particular use contemplated.

The diagrams depicted herein are illustrative. There can be many variations to the diagram or the steps (or operations) described therein without departing from the spirit of the disclosure. For instance, the actions can be performed in a differing order or actions can be added, deleted or modified. Also, the term “coupled” describes having a signal path between two elements and does not imply a direct connection between the elements with no intervening elements/connections therebetween. All of these variations are considered a part of the present disclosure.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e. one, two, three, four, etc. The terms “a plurality” are understood to include any integer number greater than or equal to two, i.e. two, three, four, five, etc. The term “connection” can include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ± 8% or 5%, or 2% of a given value.

The present disclosure may be a system, a method, and/or a computer program product at any possible technical detail level of integration. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user’s computer, partly on the user’s computer, as a stand-alone software package, partly on the user’s computer and partly on a remote computer or entirely on the remote computer or server. In the latter scenario, the remote computer may be connected to the user’s computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the present disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A computer-implemented method for managing backup of a database, the method comprising:
receiving, by a secondary database stored in a second cloud environment, a continuous replication of a primary database stored in a first cloud environment;
instructing a file system of the second cloud environment to capture a snapshot of the secondary database; and
transmitting the snapshot to a data storage system for storage,
wherein the file system of the second cloud environment utilizes logical volume management.

2. The computer-implemented method of claim 1, wherein the file system of the second cloud environment includes one of an OpenShift Data Foundation file system and a General Parallel Filesystem.

3. The computer-implemented method of claim 1, wherein the instructions to capture the snapshot of the secondary database are generated periodically.

4. The computer-implemented method of claim 3, wherein a frequency of the instructions to capture the snapshot of the secondary database are determined by a policy set by an administrator of the secondary database.

5. The computer-implemented method of claim 1, wherein the second cloud environment is further configured to store the snapshot of the secondary database in a persistent volume of the second cloud environment.

6. The computer-implemented method of claim 1, further comprising based on determining that an error occurred to the primary database, restoring the secondary database and the primary database based on a previously saved snapshot of the secondary database that was captured prior to the error.

7. The computer-implemented method of claim 6, wherein the previously saved snapshot is a most recently saved snapshot.

8. A computing system having a memory having computer readable instructions and one or more processors for executing the computer readable instructions, the computer readable instructions controlling the one or more processors to perform operations comprising:
receiving, by a secondary database stored in a second cloud environment, a continuous replication of a primary database stored in a first cloud environment;
instructing a file system of the second cloud environment to capture a snapshot of the secondary database; and
transmitting the snapshot to a data storage system for storage,
wherein the file system of the second cloud environment utilizes logical volume management.

9. The computing system of claim 8, wherein the file system of the second cloud environment includes one of an OpenShift Data Foundation file system and a General Parallel Filesystem.

10. The computing system of claim 8, wherein the instructions to capture the snapshot of the secondary database are generated periodically.

11. The computing system of claim 10, wherein a frequency of the instructions to capture the snapshot of the secondary database are determined by a policy set by an administrator of the secondary database.

12. The computing system of claim 8, wherein the second cloud environment is further configured to store the snapshot of the secondary database in a persistent volume of the second cloud environment.

13. The computing system of claim 8, wherein the operations further comprise based on determining that an error occurred to the primary database, restoring the secondary database and the primary database based on a previously saved snapshot of the secondary database that was captured prior to the error.

14. The computing system of claim 13, wherein the previously saved snapshot is a most recently saved snapshot.

15. A computer program product comprising a computer readable storage medium having program instructions embodied therewith, the program instructions executable by a processor to cause the processor to perform operations comprising:
receiving, by a secondary database stored in a second cloud environment, a continuous replication of a primary database stored in a first cloud environment;
instructing a file system of the second cloud environment to capture a snapshot of the secondary database; and
transmitting the snapshot to a data storage system for storage,
wherein the file system of the second cloud environment utilizes logical volume management.

16. The computer program product of claim 15, wherein the file system of the second cloud environment includes one of an OpenShift Data Foundation file system and a General Parallel Filesystem.

17. The computer program product of claim 15, wherein the instructions to capture the snapshot of the secondary database are generated periodically.

18. The computer program product of claim 17, wherein a frequency of the instructions to capture the snapshot of the secondary database are determined by a policy set by an administrator of the secondary database.

19. The computer program product of claim 15, wherein the second cloud environment is further configured to store the snapshot of the secondary database in a persistent volume of the second cloud environment.

20. The computer program product of claim 15, wherein the operations further comprise based on determining that an error occurred to the primary database, restoring the secondary database and the primary database based on a previously saved snapshot of the secondary database that was captured prior to the error.
